(19) United States
(12) Patent Application Publication
(10) Pub. No.: US 2004/0197146 A1
(43) Pub. Date: Oct. 7, 2004

(54) Landscaping method and apparatus

(76) Inventor: Mark D. Zingg, Phoenix, AZ (US)

Correspondence Address: Tod R. Nissle, Esq., TOD R. NISSLE, P.C., P.O. Box 55630, Phoenix, AZ, 85078, US

(21) Appl. No.: 10/406,326

(22) Filed: Apr. 3, 2003

(51) Int. Cl. E01C 11/24

(52) U.S. Cl. 404/35

(57) ABSTRACT

A method and apparatus facilitates desert landscaping by pliable, elastic sheets with surfaces shaped and dimensioned to simulate a ground cover of stones. Each sheets is produced to simulate a mixture of stones of a selected size or sizes. The sheets permit the ready removal of leaves, dirt, and other debris from the sheets. The colors of the sheets are varied as desired.

This invention pertains to landscaping.

More particularly, the invention pertains to a method and apparatus for facilitating desert landscaping.

Desert landscaping consists of using various sizes and colors of rock or gravel as ground cover, either with or without cactus, mesquite trees and other plants that typically are found in arid or semi-arid areas.

One advantage of desert landscaping is that it essentially requires no watering, even when desert plants like cactus and mesquite trees are utilized. The minimal amount of water required to maintain desert landscaping is especially important in view of nationwide drought conditions and the limitations on water use being imposed by municipal, state, and federal governments.

In the desert southwest of the United States, another advantage of desert landscaping is that it meshes with the existing desert environment and is therefore aesthetically pleasing.

A further advantage of desert landscaping is that when rock and gravel are utilized as ground cover, a thin sheet of plastic or other material normally is used to cover the ground before the rock or gravel is applied. This thin sheet blocks penetration of sunlight and water and prevents the growth of unwanted grass and weeds.

Still another advantage of desert landscaping is that it requires minimal or no maintenance. Maintaining desert landscaping ordinarily does not require fertilizer, lawn mowers, or other equipment ordinarily required for the care of grass lawns.

Still a further advantage of desert landscaping is that it helps prevent soil erosion.

One disadvantage of desert landscaping is that the rock and gravel must be mined. This increases the cost of rock and gravel and depletes a natural resource.

Another disadvantage of desert landscaping is the weight of rock and gravel. The heavy weight of rock requires the use and maintenance of dump trucks to deliver the rock. After the rock is delivered, spreading the rock over the ground is a laborious, time consuming task.

A further disadvantage of using rock and gravel in desert landscaping is that removing the rock or gravel to replace it with sod or cement is difficult and seldom is done.

Still another disadvantage of desert landscaping is that the jagged edges often found on rocks and gravel make it difficult to walk on the rocks and gravel, particularly when the rocks and gravel have absorbed heat from the summer sun.

Still a further disadvantage of desert landscaping is that leaves and small twigs wedge between rocks, making removal of the leaves and twigs difficult, even with a leaf blower.

Yet another disadvantage of desert landscaping is that dirt and mulch (from dead leaves and twigs) gradually accumulates in the rocks, enabling weeds to gain a foothold and grow between the rocks.

Accordingly, it would be highly desirable to provide an improved method and apparatus for desert landscaping that both would preserve many benefits associated with desert landscaping and would eliminate at least some of the disadvantages associated with desert landscaping.

Therefore, it is a principal object of the instant invention to provide an improved method and apparatus for implementing desert landscaping.

Another object of the invention is to provide an improved desert landscaping method and apparatus that would not require large trucks to deliver rock and gravel.

A further object of the invention is to provide a method for installing desert landscaping with minimal effort and cost.

Still another object of the invention is to provide improved desert landscaping that permits the ready removal of leaves, sticks, and other debris.

Still a further object of the invention is to provide an improved desert landscaping method and apparatus that is environmentally friendly.

Yet another object of the invention is to provide an improved desert landscaping method and apparatus that significantly reduces the likelihood that over time weeds will be able to gain a foothold in the landscaping.

Yet a further object of the invention is to provide an improved desert landscaping that can be readily removed to permit the installation of sod, concrete, or other alternate ground coverings.

These and other, further and more specific objects and advantages of the invention will be apparent from the following detailed description of the invention, taken in conjunction with the drawings, in which:

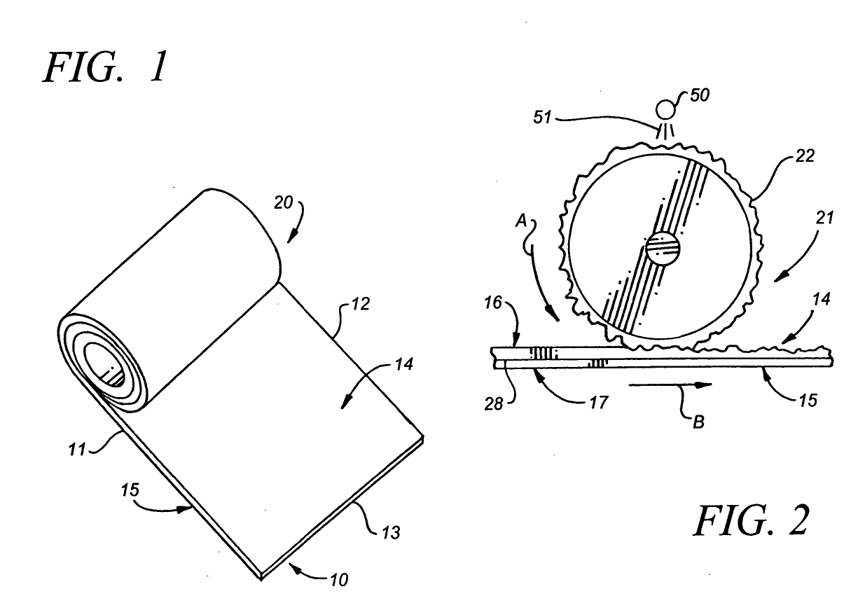

FIG. 1 is perspective view illustrating a roll of desert landscaping sheet produced in accordance with the principles of the invention;

FIG. 2 is a side elevation view illustrating a method of manufacturing the sheet of FIG. 1;

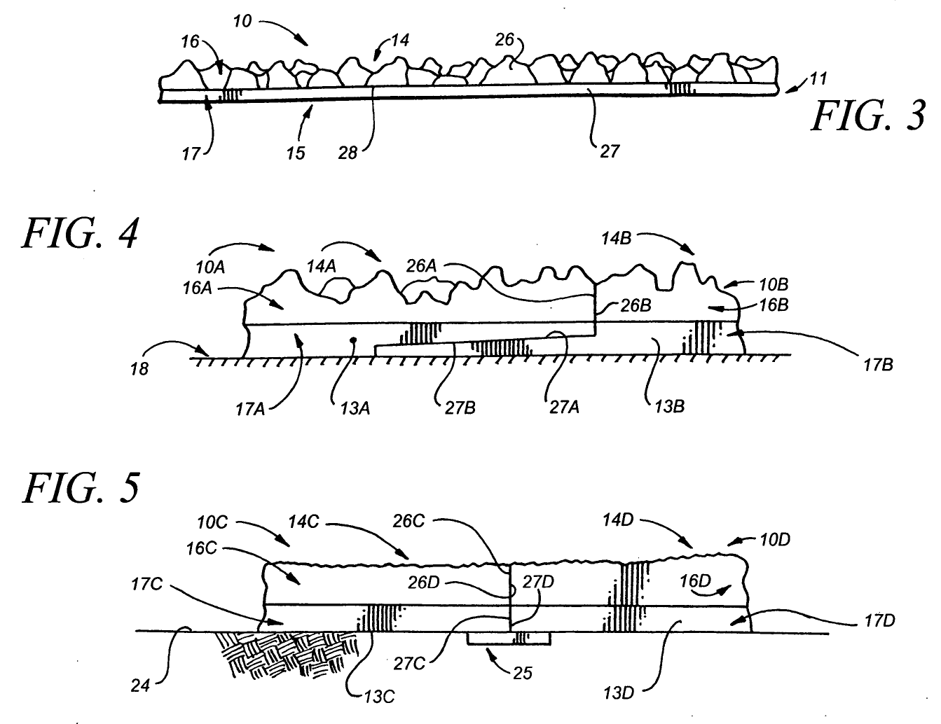

FIG. 3 is an enlarged side view illustrating a portion of the sheet of FIG. 1;

FIG. 4 is an enlarged side view illustrating one method for sealing together the juxtaposed side edges of a pair of desert landscaping sheets to prevent weeds or water from penetrating between the pair of sheets;

FIG. 5 is an enlarged side view illustrating another method for sealing together the juxtaposed side edges of a pair of desert landscaping sheets;

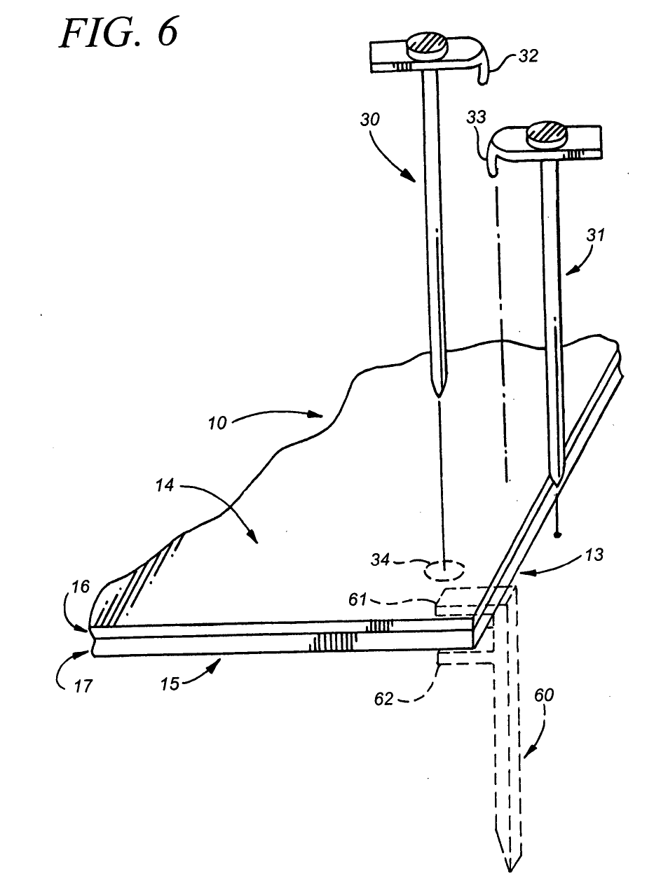

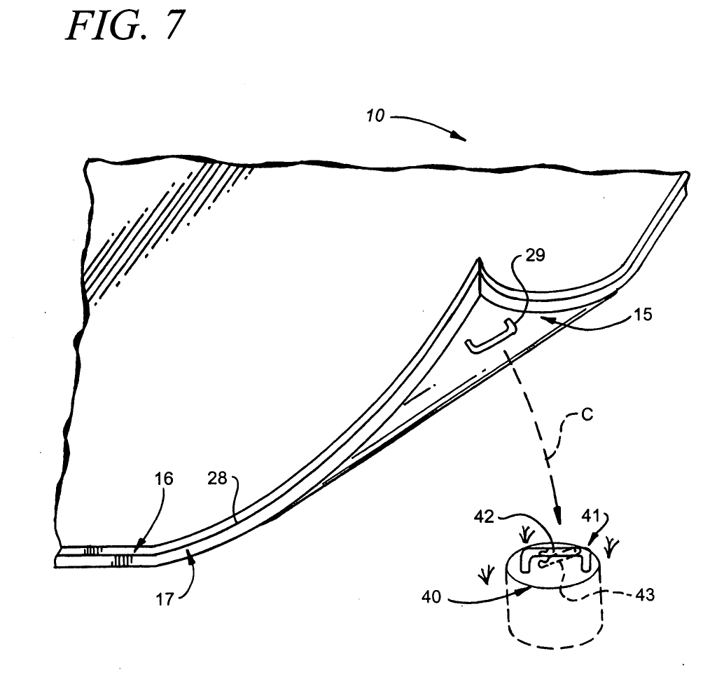

FIG. 6 is a perspective view illustrating several procedures for securing a desert landscaping sheet to the ground; FIG. 7 is a perspective view illustrating another procedure for securing a desert landscaping sheet to the ground;

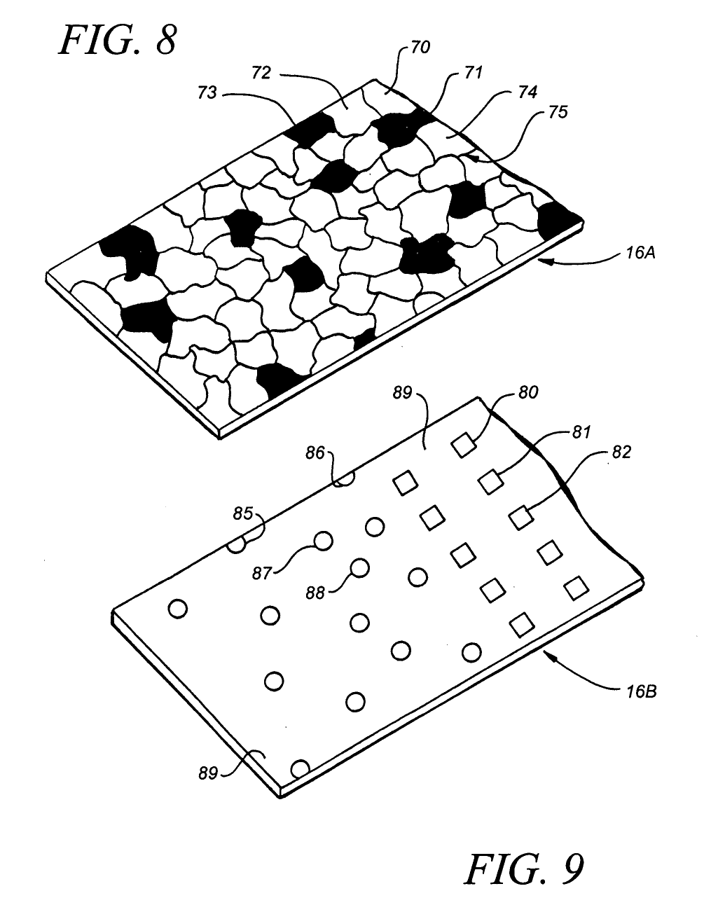

FIG. 8 is a perspective view illustrating one coloring scheme that can be used in producing a desert landscaping sheet in accordance with the invention; and,

FIG. 9 is a perspective view illustrating another coloring scheme that can be used in producing a desert landscaping sheet in accordance with the invention.

Briefly, in accordance with my invention, I provide improvements for use with an area on the top of the ground. The improvements permit landscaping of the area and comprise a pliable sheet shaped and dimensioned to cover the area, the sheet including a peripheral edge, a bottom, and a top. The top is shaped and dimensioned to simulate the shape and color of a plurality of stones.

In another embodiment of my invention, I provide an improved method for producing a pliable sheet to simulate the appearance on the ground of a plurality of stones covering the ground. The method includes the steps of producing a pliable sheet of material including a deformable layer of a polymer foam; providing a roller having a surface shaped and dimensioned to simulate an impression produced from a plurality of stones covering the ground; heating the surface of the roller; and, moving the surface over the deformable layer of polymer foam such that the layer of polymer foam conforms to the surface and takes on a shape and dimension simulating the appearance on the ground of a plurality of stones.

In a further embodiment of my invention, I provide an improved method for landscaping an area on the top of the ground to simulate the appearance of a plurality of stones covering the ground. The method includes the steps of providing at least two pliable sheets, each of the sheets including a peripheral edge including at least one side edge, and including a top, the top being shaped and dimensioned to simulate the shape and color of a plurality of stones; covering the area of ground with the pliable sheets such that the side edges are adjacent; securing the side edges adjacent each other; and, securing at least a portion of said peripheral edge to the ground.

Turning now to the drawings, which depict the presently preferred embodiments of the invention for the purpose of illustrating the practice thereof and not by way of limitation of the scope of the invention, and in which like reference characters refer to corresponding elements throughout the several views, FIG. 1 illustrates a roll 20 of a pliable sheet 10 of material fabricated in accordance with the invention. Sheet 10 includes leading edge 13, side edge 11, and side edge 12. Edge 12 ordinarily, but not necessarily, is parallel to edge 11. Edges 11 and 12 ordinarily, but not necessarily, are normal to leading edge 13. Sheet 10 also includes bottom surface 15 and upper surface 14. The size of sheet 10 can vary as desired, but a sheet 10 that is six feet wide and ten feet long is presently anticipated. The weight of roll 20 can also vary as desired, but is preferably no more than thirty pounds.

A sheet 10 can comprise one or more layers of polymer foam, rubber, or other materials. As is illustrated in FIG. 3, sheet 10 presently preferably includes a first under layer 17 of rubber and a second upper layer 16 of polymer foam. Layer 16 is secured to layer 17 with adhesive or by any other desired means.

Layer 16 consists of a sheet having parallel upper and lower surfaces. Layer 16 is then, either before or after being secured to layer 17, directed into contact with a roller 21 in the manner illustrated in FIG. 2. Roller 21 includes a surface 22. Surface 22 is shaped and dimensioned to replicate an impression of the type that results when soft deformable molding clay or other molding material is pressed against a layer of stones having dimensions falling within a desired range. When the molding material is pressed against the layer of stones, a “negative” impression is formed in the molding material. The molding material is then removed from the stones and retains the negative impression produced when the molding material was initially pressed against the stones. It is this sort of negative impression that is formed in surface 22. Procedures for producing such an impression in surface 22 are known in the art and are not detailed herein. Surface 22 can, if desired, be formed in a sleeve that slides over or is otherwise mounted on a roller 21.

In FIG. 2, surface 22 is heated. When a laminate sheet consisting of layers 16 and 17 is contacted by heated surface 22, surface softens and deforms layer 16 to form a surface 14 having a shape, contour, and dimension that simulates the appearance of a layer of stones. The size and shape of stones replicated by surface 14 can vary as desired. The stones typically have a width of from about 1/32″ (for replicating sand) up to about 6″ (for replicating larger stones). The stones replicated by surface 14 can each be approximately the same size or can vary in size. The stones would vary in size if, for example, gravel is being replicated by surface 14.

Heated surface 22 also functions to soften the surface of layer 16 that is contacting surface 22 and to close openings or pores that may exist on the surface 14 of layer 16. Such a closing of pores improves the ability of layer 16 to avoid absorbing moisture. The heating of the surface of layer 16 can also function, when the surface of layer 16 subsequently cools, to harden the surface of layer 16 and make it more resistant to being torn or other wise damaged.

Roller 21 rotates in the direction of arrow A while layers 16 and 17 move in the direction of arrow B. While roller 21 rotates, a sprayer 50 can apply to surface 22 paint having a desired color. At least a portion of the paint transfers from surface 22 of layer 16 when layer 16 is deformed by surface 22. If desired, paint can be applied to layer 16 before or after layer 16 is deformed by heated surface 22. One or more coatings or colors of paint can be applied simultaneously or at different times to all or portions of layer 16 or surface 14.

Sprayer 50 can be utilized to apply chemicals to surface 22 that are transferred from surface 22 to layer 16 during the deformation of layer 16 by surface 22. Such chemicals can have any desired function. One function is to increase the ability of surface 14 to resist absorbing water. Another function is to prevent surface 14 from sticking to surface 22.

Layer 17 is presently preferably made from rubber, in particular, rubber from old discarded tires. Such a use of old tires is environmentally desirable because old tires litter dump sites and because removal of such tires poses a serious ecological problem. Government may allow tax breaks for companies that facilitate the disposal of old tires. In addition, rubber is less likely to tear or be damaged than is the thin sheet presently utilized under rock and gravel landscaping.

Layer 16 is presently preferably made from foam rubber. Foam rubber is preferred because it is relatively easy to mold when heat is applied and the foam rubber is deformed, because heat tends to seal the pores in foam rubber to form a tough, water-resistance surface on the foam rubber, and because it resiliently compresses when walked on. The thickness of the foam rubber layer 16 can vary as desired, but is presently in the range of about one-eighth of an inch to ten inches, preferably one-fourth of an inch to six inches. The thickness of layer 17 can also vary as desired, but is presently in the range of about one-thirty second of an inch to one inch, preferably about one-eighth of an inch to one quarter of an inch.

Layer 16 can be comprised of a material having a desired color such that paint need not be applied to layer 16 while layer 16 is shaped and dimensioned by heated surface 22, and, such that paint need not be applied to layer 16 after it is shaped and dimensioned by surface 22.

FIG. 3 is an enlarged view of the side edge 11 of desert landscaping sheet 10 and illustrates bottom surface 15 and upper contoured surface 14. Edge 11 includes edge 27 of layer 17 and edge 26 of layer 16.

FIG. 4 illustrates desert landscaping sheets 10A and 10B. Sheet 10A includes layer 16A with contoured surface 14A. Layer 16A is permanently affixed to layer 17A with adhesive or other fastening materials or methods. Layer 17A includes feathered or tapered edge 27A. Sheet 10B includes layer 16B with contoured surface 14B. Layer 16B is permanently affixed to layer 17B with adhesive or other fastening materials or methods. Layer 17B includes feathered or tapered edge 27B shaped and dimensioned to interfit and under lay edge 27A in the manner illustrated in FIG. 4. Edges 27A and 27B can be secured together with adhesive, clips, heat welding, or any other desired means. Sheet 10A includes leading edge 13A. Sheet 10B includes leading edge 13B. Layer 16A includes edge 26A. Layer 16B includes edge 26B parallel to edge 26A.

FIG. 5 illustrates sheets 10C and 10D. Sheet 10C includes layer 16C with contoured surface 14C. Layer 16C is permanently affixed to layer 17C with adhesive or other fastening materials or methods. Layer 17C includes edge 27C. Sheet 10D includes layer 16D with contoured surface 14D. Layer 16D is permanently affixed to layer 17D with adhesive or other fastening materials or methods. Layer 17D includes edge 27D parallel to edge 27C. Edges 27C and 27D and 26C and 26D can, if desired, be secured together with adhesive, clips, heat welding, or any other desired means. Sheet 10C includes leading edge 13C. Sheet 10D includes leading edge 13D. Layer 16C includes edge 26C. Layer 16D includes edge 26D parallel to edge 26C. Elongate strip 25 bridges and is glued or otherwise secured to the bottom of sheets 10C and 10D to hold edges 26C and 27C against juxtaposed edges 26D and 27D. Strip 25 can be provided in rolls similar to roll 20. Strip 25 extends parallel to edges 26C, 26D, 27C, and 27D.

In FIGS. 2, 3, 4, surfaces 14 and 14A and 14B are shaped and dimensioned to simulate larger stones. In FIG. 5, surface 14D is shaped and dimensioned to simulate sand or other small stones.

FIG. 6 illustrates one method for securing the peripheral edge of a sheet 10 once the sheet has been placed in a desired position over an area of the ground 24 or other surface 24. In FIG. 6, a tent stake 30 can be driven into the ground through a portion of sheet 10, or can be driven into the ground through an opening formed through sheet 10 and indicated by dashed lines 34. Lip 32 of stake 30 then presses sheet 10 against the ground. A stake 31 can be used in place of or in addition to stake 30. Stake 31 is not driven through sheet 10, but is driven into the ground at a point adjacent an edge of sheet 10. Lip 32 again functions to engage and press sheet 10 against the ground. In another fastening system, an anchor stake 60 includes spaced apart arms 61 and 62 that engage and hold in place the edge of sheet 10.

FIG. 7 illustrates yet another system for securing a sheet 10 in place on the ground. One or more concrete footings 40 are formed in the ground. A clip 41 is anchored in the concrete footing 40. Clip 41 includes a spring-loaded arm 42. Arm 42 can be opened to the position indicated by dashed lines 43 so that handle 29 can be secured in clip 41. Handle 29 is fixedly secured to the bottom 15 of sheet 10. If desired, footing 40 and clip 41 can be recessed in the ground to insure that bottom 15 is flush with the ground and is not pressed upwardly away from the ground by handle 29 when handle 29 is in clip 41. Handle 29 can be fabricated from any desired material but preferably is made from rubber or another polymer.

In use, desert landscaping sheets 10 are manufactured using the process described with respect to FIG. 2, or using some other desired process. The resulting sheets 10 can be stored in a flat orientation stacked one on top of the other or can be rolled 20 in the manner illustrated in FIG. 1. An area of ground is selected. If necessary and desired, the ground is cleared of trees, shrubs, or other growth or materials to prepare the area to receive desert landscaping sheets 10. One or more sheets 10 are placed over the area of ground. When two or more sheets are placed adjacent one another, the seams or spaces between the adjacent sides of sheets are preferably sealed by using a strip 25 (FIG. 5), by affixing overlapping edges to one another (FIG. 4), or by some other desired procedure. Tent stakes 30 or 31, stakes 60, anchor clips 41, or any other desired means is used to secure adjacent the ground selected points on the periphery of the adjoined sheets. Leaves, dirt, sticks, and other debris that accumulates on the adjoined desert landscaping sheets is readily removed with a leaf blower, broom, pressurized air, or water hose. In the event it is desired to remove the desert landscaping sheets to apply sod, concrete, or some other material to the area of ground covered by the sheets, such is readily accomplished by removing the stakes 30, 31, 60 or detaching handles 29 from clips 41, by cutting along the seam lines intermediate adjacent pair of sheets 10, and by rolling up the sheets 10 and removing the rolls from the area of ground.

As noted, surface 22 can be fabricated to produce, when rolled over layer 16, a replication of a layer or layers of stones wherein each stone has any desired height, width, shape and dimension. For example, surface 22 can be formed to shape and contour layer 16 to produce in layer 16 stone replicas that simulate stones each having a width and height of about one-half inch. The stone replicas in contoured layer 16 can, for example, each be rounded and smooth, like “river rocks”, can each be angular with edges, or can be a combination of smooth and angular stones.

Sleeves can be provided that slide over or are otherwise removably mounted on a roller 21 and that have surfaces 22 with differing shapes and dimensions can be provided. For example, one sleeve can have a surface 22 that will contour layer 16 to simulate a layer or layers of stones comprised of large river rocks. Another sleeve can have a surface 22 that will contour layer 16 to simulate a layer or layer of stones comprised of small gravel.

Alternatively, a plurality of rollers can be provided. Each roller would have a surface 22 that is shaped and dimensioned and contoured differently than the surfaces 22 on the other rollers. The rollers can be rotatably mounted in, removed from, and substituted for each other along a production line.

In another embodiment of the invention, rectangular panels are provided. Each panel is used as a stamp, includes a generally planar shaping surface that is contoured like surface 22 and functions to shape and contour a layer 16, and is pressed against a flat rectangular foam layer 16 so that the generally planar shaping surface shapes and contours the surface of the foam to simulate the appearance of a layer or layers of stones.

When real stones are spread over the ground during desert landscaping to cover the ground, the resulting layer rocks does not have the same appearance at all points on the layer. This variation in appearance normally results because each stone does not have the same exact color at each point on the stone and because the stones produce shadows. Consequently, the layer of stones normally has a somewhat mottled appearance, even if all the stones supposedly have the “same” color. In one embodiment of the invention, this mottled appearance is simulated by producing layer 16 with a surface that is colored to produce a mottled appearance before the layer 16 is contoured by a surface 16. In another embodiment of the invention, this mottled appearance is simulated by, after layer 16 is contoured by a surface 22, painting or otherwise processing layer 16 to produce on layer 16 different shades, or colors, of paint. Any desired apparatus or method can be utilized to produce a mottled appearance that will more closely replicates the appearance of an actual layer of stones. The stone replicas in a layer 16 contoured by a surface 22 normally will produce shadows in sunlight, especially when the sun is not directly overhead but is in a lower position in the sky.

One possible mottled appearance of layer 16 is illustrated in FIG. 8, where the mottled layer 16 is identified by reference character 16A. In FIG. 8, layer 16A is illustrated prior to its being shaped and dimensioned and contoured by a surface 22 in the manner illustrated in FIG. 2. Each contiguous area 70 to 74 on the surface of layer 16A can be the same color or can be a different color. Or, a selected number of areas 70 to 74 can be the same color while others of areas 70 to 74 are a different color. The lines of demarcation 75 between continuous areas 70 to 74 can be a different color than areas 70 to 74. In FIG. 8, some areas 71 and 73 are colored black, while other areas 70, 72, 74 are colored white. Areas 71 to 74 can be colored with any desired color or combination or mixture of colors.

Another possible mottled appearance of layer 16 is illustrated in FIG. 9, where the mottled layer 16 is identified by reference character 16B. In FIG. 9, layer 16B is illustrated prior to its being shaped and dimensioned and contoured by a surface 22 in the manner illustrated in FIG. 2. As is illustrated in FIG. 9, colored areas 80 to 82 can be formed on the surface of layer 16B in a designated fixed pattern, and/or colored areas 85 to 88 can be formed on the surface of layer 16B in a random manner.

A layer of actual stones typically also includes undercut or recessed surfaces, indents, detents, or notches. Shaping layer 16 to include such recessed surfaces makes layer 16 look more realistic.

A layer of real stones typically also includes stones that do not each have the identical shape. Even when each stone in a layer is about the same size, the curvature or other shape of each stone ordinarily differs from that of the other stones. Shaping layer 16 to include such a variation in the shape and dimension of each stone, or at least some of the stones, makes layer 16 appear more realistic.

A layer of real stones typically also includes stones that do not each have the same orientation. E.g., one stone rests on its side, another stone rests on its base, etc. Shaping layer 16 to include stones having different orientations makes layer 16 appear more realistic.

A layer of actual stones typically also includes stones that are resting on other stones. E.g., each stone does not rest on and directly contact the ground. Only the uppermost stones in the layer are visible to an observer. These uppermost stones normally each rest on other stones positioned between the ground and the uppermost stones. Shaping layer 16 to replicate the appearance of uppermost stones resting on other stones makes layer 16 appear more realistic. Replicating this appearance is preferably achieved through coloring and not by forming nooks and crannies in which leaves, dirt, and twigs become lodged and accumulate.

Having described my invention in such terms as to enable those of skill in the art to make and practice it, and having described the presently preferred embodiments thereof, I Claim:

1. In combination with an area on the top of the ground, the improvements for landscaping said area, said improvements comprising a pliable sheet shaped and dimensioned to cover said area, said sheet including a peripheral edge, a bottom, and a top, said top being shaped and dimensioned to simulate the shape and color of a plurality of stones.

2. A method for producing a pliable sheet to simulate the appearance on the ground of a plurality of stones covering the ground, said method including the steps of
(a) producing a pliable sheet of material including a deformable layer of a polymer foam;
(b) providing a roller having a surface shaped and dimensioned to simulate an impression produced from a plurality of stones covering the ground;
(c) heating said surface of said roller;
(d) moving said surface over said deformable layer of polymer foam such that said layer of polymer foam conforms to said surface and takes on a shape and dimension simulating the appearance on the ground of a plurality of stones.

3. A method for landscaping an area on the top of the ground to simulate the appearance of a plurality of stones covering the ground, including the steps of
(a) providing at least two pliable sheets, each of said sheets including a peripheral edge including at least one side edge, and including a top, said top being shaped and dimensioned to simulate the shape and color of a plurality of stones;
(b) covering the area of ground with said pliable sheets such that said side edges are adjacent;
(c) securing said side edges adjacent each other; and,
(d) securing at least a portion of said peripheral edge to the ground.
